(19) United States
(12) Patent Application Publication
(10) Pub. No.: US 2008/0300903 A1
(43) Pub. Date: Dec. 4, 2008

(54) DELIVERY/PICKUP SERVICE ACTIVATOR AND ADVISOR

(75) Inventor: Rene R. Lundy, Bend, OR (US)

Correspondence Address: PEDERSEN & COMPANY, PLLC, P.O. BOX 2666, BOISE, ID, 83701, US

(73) Assignee: BELLATRIX SYSTEMS, Bend, OR (US)

(21) Appl. No.: 11/940,980

(22) Filed: Nov. 15, 2007

Related U.S. Application Data
(60) Provisional application No. 60/859,462, filed on Nov. 15, 2006.

(51) Int. Cl. G06Q 10/00

(52) U.S. Cl. 705/1

(57) ABSTRACT

A computer device for activating and reporting on delivery/pickup service is disclosed. The device has a button connected to a computer. Software on the computer is activated by a user pressing the button to contact a delivery/pickup service via the internet, schedule service according to selections made by the user, and indicate on the computer display screen, and optionally also on the button, that service has been scheduled. This way, the delivery/pickup service is scheduled efficiently, and the user's computer station is informed/reminded that service has been scheduled.

This application claims priority from U.S. Provisional Application 60/859,462, filed Nov. 15, 2006, which is incorporated herein by reference.

### BACKGROUND

1. Field

This invention relates generally to the field of parcel delivery and pickup. More specifically, this invention relates to a computerized device for conveniently ordering delivery or pickup services, and for conveniently notifying and reminding employees that delivery/pickup services have been ordered. Iii addition, the device may also correspond with the databases of the customer and/or the delivery/pickup service provider for record keeping and accounting.

2. Related Art

U.S. Pat. No. 5,648,770 (Ross) discloses a system for notifying a party of a pending delivery or pickup. The system includes a GPS-type unit on the delivery vehicle, and a communications link to the party expecting the delivery/pickup.

U.S. Pat. No. 6,748,320 (Jones) discloses an advance notification system for arrival of a vehicle. The system includes an on-board vehicle control unit (VCU) and a base station control unit (BSCU) for sending messages to customer computers regarding the vehicle's itinerary.

U.S. Pat. No. 7,248,160 (Mangan et al.) discloses a computerized tracking system utilizing a cell phone/GPS network. For example, a courier carries a mobile phone that is connected to a barcode scanner, and programmed with tracking software. This way, the courier can log in, retrieve the service schedule, verify each service location, log arrival and departure time, scan packages for pickup and delivery, and sign off.

### SUMMARY OF THE INVENTION

Many homes and businesses that utilize delivery or pickup services have intermittent need for service. In addition there are many competing services to choose from. In order to schedule service, the customer must contact the service via telephone or the internet, fill in a questionnaire or answer several questions. This uses an excessive amount of the customer's time. Further, the services do not have a way to influence the choice of the business, as the service may have no visible advertising in the customer's location. Finally, after one employee of the customer has scheduled a service, there is no clearly visible indication that a service is scheduled, possibly leading to confusion and multiple contacts to the same or different service by other employees. The need is for a delivery/pickup activator that is quick and easy to use, provides a visible indication that a service has already been scheduled, optionally advertises the preferred service(s), and optionally corresponds with the databases of the customer and/or the delivery/pickup service provider.

A button enclosure for attachment or connection to a PC and attending software running on the PC work together to provide the needed functionality. The enclosure presents a large and easy to activate button or selection of buttons to the user. Upon activation of a button, a signal is sent to the PC software. The PC software is pre-programmed to contact the service of choice via the internet, log into the customer's account if required, and schedule service according to a default series of selections made by the customer. Once the service has been scheduled and accepted by the courier's software, the PC software presents a large indication on the PC display and sends a signal to the button enclosure. Upon receiving the signal from the PC, a button of the button enclosure lights up, for example, to provide another indication that service has been scheduled. Alternatively, the button enclosure may have a display screen of its own which is utilized to indicate that service has been scheduled.

In addition, the button enclosure may have a large area for the display of advertising by the available service(s). The lighted button enclosure extinguishes automatically at some interval, or may be actively turned off, after the service has occurred. The large screen indication provided by the PC software may be reduced to a small indication upon use of the PC for other reasons. Changes to the default selections for time of service, type of service, etc. are available at any time. If the type of service requires additional selections (i.e. weight of a package, pizza ingredients, etc.) at the time of scheduling beyond those made by default, those options are automatically displayed when the button enclosure is activated.

Additional buttons may be installed in the enclosure to provide for the selection of different services from one or more different service providers, and may be represented when activated by different lighting in the enclosure and different display indication by the PC software. The button enclosure may be attached to the PC via any hard-wired or wireless communication port.

### BRIEF DESCRIPTION OF THE DRAWINGS

FIG. 1 is a schematic, perspective depiction of one embodiment of the instant invention with a one-button enclosure.

FIG. 2 is a schematic, perspective depiction of another embodiment of the instant invention with a multiple button enclosure, and with a large area for display of advertising by the available services.

### DETAILED DESCRIPTION OF THE INVENTION

Referring to the Figures, there are depicted several, but not all, embodiments of the present invention.

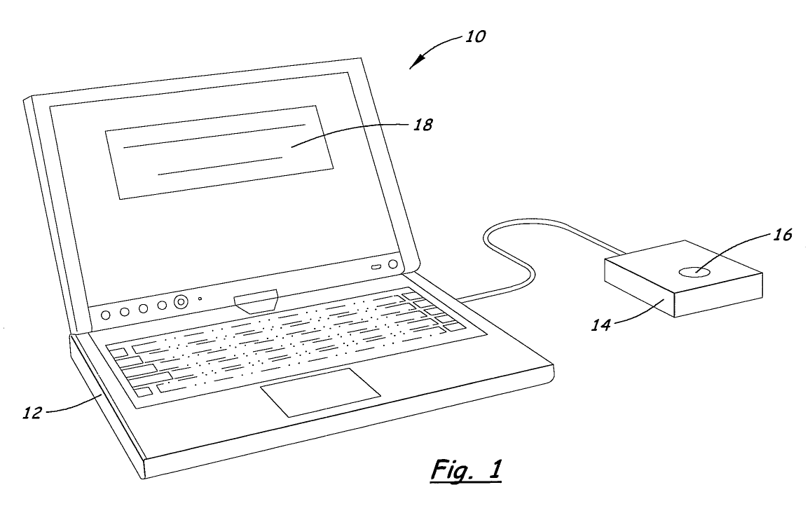

FIG. 1 depicts a one-button enclosure embodiments 10 of the present invention. Personal computer (PC) 12 has delivery/pickup button enclosure 14 attached. Button 16 is prominently situated on the front of button enclosure 14. When button 16 is depressed, a signal is sent to the PC 12 software. The PC 12 software is pre-programmed to contact the selected service of choice, FedEx for example, via the internet, log into the customer's account if required, and schedule service according to a default series of selections made by the customer. A pre-set menu of the selected service may present itself to the customer on the PC screen for convenience. Once the service has been scheduled and accepted by the courier's software, the PC 12 software presents a large indication 18 on the PC screen, and sends a signal to the button enclosure 14. Upon receiving this signal from the PC 12, the button 16 on button enclosure 14 lights tip to provide an indication that the service has been scheduled. Alternatively, or in addition, the PC 12 software may present an indication 18 on the screen of other PC's networked with it. This way, other employees, even at other PC stations, will also be advised about the fact that the service has been scheduled.

Also, the lighted button 16 may extinguish automatically at some interval after the service has occurred. Alternatively, the lighted button 16 may be actively turned off after the service has occurred. In this vein, pickup and delivery services have need for the ability to audit the time and location of pickup drivers as they service their route. This information can contribute to efficiency, planning, marketing, and sales functions within the organization. Also, the customer could be freed from having to indicate to themselves and others that service had occurred if a service activator would also automatically indicate that a visit from the driver had occurred.

In order to answer these needs, the service activator can be optionally equipped with a two-way communication device. This device communicates with all electronic recorder carried by the service driver. Upon visiting the customer with the service activator, a record of the time and service indicator ID is recorded in the driver's device. At some point after the visit, the recorded information is sent from the driver to the package pickup and delivery organization, and linked with the customer information for processing. In addition, at the time of communication, the service activator would extinguish or change its indicators to show the customer that a service had occurred. One embodiment of the electronic recorder could be the handheld electronic device currently carried by the service driver. One embodiment of the communication device could be through use of infrared communication ports on the driver's hand-held device and also on the service activator.

Also, the large PC 12 screen indication 18 provided by the PC software may be reduced to a smaller indication upon use of the PC 12 for other reasons.

Also, upon activation of button 16, changes to the default selections for time of service, type of service, etc. are presented to the customer. This way, customized orders for the available services may be made by the customer. If the type of service requires additional selections at the time of scheduling beyond those made by default (i.e. weight of a package, pizza ingredients, etc.), those additional options are automatically displayed to the customer when the button 16 is activated.

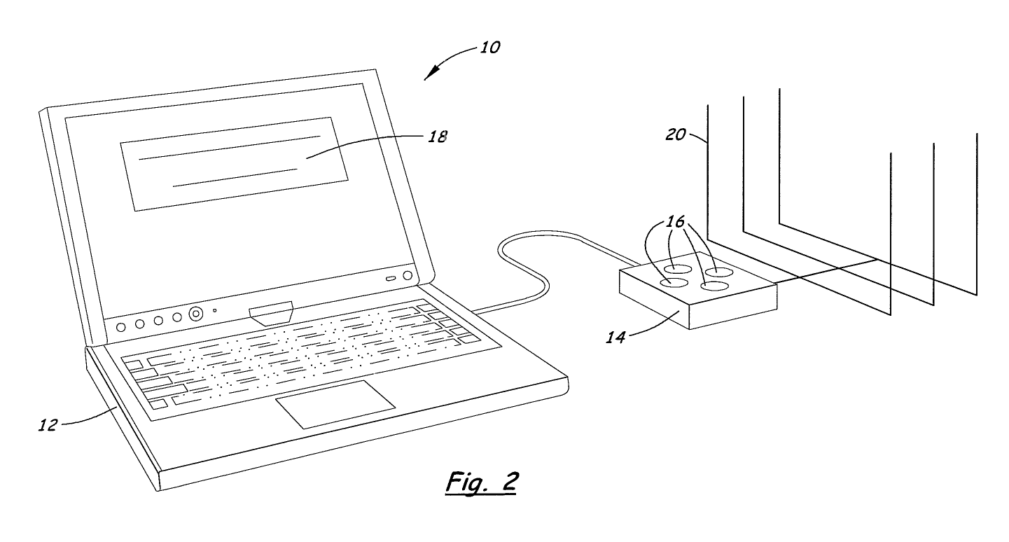

Furthermore, additional buttons may be installed in the button enclosure 14 to provide for the selection of different competing services, for example. Or, additional buttons may also be installed in the button enclosure 14 to provide for the selection of different types of services, for example, pizza as well as package delivery. In these cases, upon activation of the different buttons, only those activated buttons may be lighted and, optionally, lighted differently, and also represented by different display indications 18. In this vein, see FIG. 2.

In addition, button enclosure 14 may have attached or associated with it a large area like pamphlet rack 20 depicted in FIG. 2 for display of advertising, rates, procedures, etc. by the available services. This way, the customer may be conveniently informed and/or reminded of the different services available.

The attending PC 12 software, including display indications 18, may be conventional correspondence, service ordering, and tracking software. Even firmware may suffice for simpler software applications. Likewise, the constriction of button enclosure 14 and button 16 may be conventional. The button enclosure 14 may be attached to the PC 12 via any conventional hard-wired or wireless communication port.

Although this invention has been described above with reference to particular means, materials and embodiments, it is to be understood that the invention is not limited to these disclosed particulars, but extends instead to all equivalents within the scope of the following claims.

What I claim is:

1. A delivery/pickup service activator and advisor, comprising:
a button enclosure for attachment or connection to a computer, the button enclosure comprising a button and the computer comprising a display screen.
software on the computer which, when activated by a user pressing a button of the button enclosure, contacts a delivery/pickup service via the internet, schedules service according to selections made by the user, and indicates for the computer display screen that service has been scheduled.

2. The activator and advisor of claim 1 wherein the button enclosure also comprises a light, and the computer software sends a signal to turn on the light when service has been scheduled.

3. The activator and advisor of claim 1 wherein the button enclosure also comprises a display screen, and the computer software sends a signal to activate the display screen when service has been scheduled.

4. The activator and advisor of claim 1 wherein the computer software communications with the delivery/pickup service provider for record keeping and accounting.

5. The activator and advisor of claim 1 wherein the computer software communicates with the customer for record keeping and accounting.

6. The activator and advisor of claim 1 wherein the computer software communicates with both the delivery/pickup service provider and the customer for record keeping and accounting.

7. The activator and advisor of claim 1 wherein the computer software also indicates for other computers networked to the computer that service has been scheduled.

8. The activator and advisor of claim 1 which also comprises a two-way communication device that communicates the time and location of service to the delivery/pickup service provider.

9. The activator and advisor of claim 1 wherein the button enclosure comprises a plurality of button-s.

10. The activator and advisor of claim 1 wherein the button enclosure also comprises a large area for advertising for available services.
